(19) United States
(12) Patent Application Publication
(10) Pub. No.: US 2007/0064290 A1
(43) Pub. Date: Mar. 22, 2007

(54) Device for making a reflection hologram

(76) Inventors: Gerhard Hochenbleicher, (US); Peter Bauernschmid, (US)

Correspondence Address: Daniel L. Dawes;Myers Dawes Andras & Sherman LLP, Suite 1150, 19900 MacArthur Boulevard, Irvine, CA, 92612, US

(21) Appl. No.: 11/473,211

(22) Filed: Jun. 21, 2006

(30) Foreign Application Priority Data
Jun. 27, 2005 (DE) 10 2005 029 853.2

(51) Int. Cl. G03H 1/04

(52) U.S. Cl. 359/22; 359/35

(57) ABSTRACT

The present invention relates to a device for producing a reflection hologram, comprising a master hologram 1 which comprises at least one color-sensitive reflective layer, a photosensitive film 2 applied to the master hologram, and a filter 3 which is arranged on the film and through which light is passed onto the master hologram 1 and reflected towards the film 2, and a laser light source 4 which outputs white or monochromatic light.

The present invention relates to a device for making a reflection hologram.

In detail, the present invention relates to a device with the help of which reflection holograms can easily be made at low costs in great numbers and in an individualized manner.

When reflection diagrams are made for security relevant applications, for instance non-forgeable identity cards, credit cards, or the like, it is desirable to obtain an individualized reflection hologram in the case of which for example a photograph of the holder of the credit card or the identity card is contained in the reflection hologram. This may be the case in addition to further security features, for example armorial bearings, patterns, or the like.

The devices known from the prior art require either great efforts in terms of technical equipment, or they are not suited for an individualization of the reflection hologram.

Practical Holography, eds. Saxby, Grahm, 1988, page 122, describes a standard contact copying method in which white light is used. Furthermore, a very small-band filter is used. Colored copies are thus not producible.

U.S. Pat. No. 3,647,289 describes a method and a device for copying holograms, in which an intensity control is carried out in the making of a contact copy so as to match the intensity of the object light and of the reference beam to each other.

It is known from US 2004/0175627 A1 that the higher orders of the grating in transmission holograms are eliminated.

It is the object of the present invention to provide a device of the above-mentioned kind which while being of a simple construction and easily usable at low costs permits the individual construction of reflection holograms, particularly colored ones.

According to the invention this object is achieved by the feature combination of the main claim; the sub-claims show further advantageous developments of the invention.

Hence, according to the invention a master hologram is provided on which a film to be exposed is placed, on which film, in turn, a filter is positioned. The whole arrangement is exposed through the filter and the film by means of a laser light source with laser. The laser light is here selectively filtered for the individual color pixels by the filter and correspondingly reflected for the individual colors by the master hologram, which acts as a mirror. This reflected light that is decomposed into individual color pixels or color dots will then expose the film.

Hence, according to the invention it is possible in a particularly simple way to produce an individualized reflection hologram on the film, which hologram may particularly be multicolored and reproduces the information that is positioned on the filter.

Hence, according to the invention it is possible to produce the filter by means of a printing technique, for instance by means of an ink jet printing method. This multicolored image, which is applied as information original as filter, is thus exposed pixelwise upon reflection of the laser light by the master hologram on the film and is fixed there. This creates a reflection hologram that can reproduce colored information. The procedure according to the invention is particularly advantageous due to the fact that the filter can be produced in a very simple and inexpensive manner. For instance, it is possible in the case of identity cards to print a color photograph of a person with a commercial ink jet printer in colors and to incorporate it into a reflection hologram.

Hence, according to the invention it is particularly advantageous that hologram copies can be made by using a printed film that is producible at low costs. No further adjustment or the like is here needed for a reproduction that is true to color.

A laser scanner is preferably used as the laser light source. According to the invention the laser light source is preferably in the form of a white laser beam that consists at least of the three colors (red, yellow, blue).

The white laser beam can e.g. be produced from three individual lasers via dichroitic mirrors.

As an alternative, however, it is also possible to use monochromatic laser light. This yields a basic coloration of the reflection hologram.

The filter according to the invention is preferably configured in the form of a transparent film printed with information. However, it is also possible to apply the information in a different way to the filter. Dissolved dyes or pigments may here be used that are applied by means of a printing method (in an additive or subtractive way). As described, it is possible according to the invention to provide the filter with multicolored information. It is however also possible within the scope of the invention to make the filter monochromatic. In a modification of the invention, it might also be possible to configure the filter itself, at least in part, as a hologram.

In the device according to the invention, a control or synchronization of the laser beam can be omitted in the case of an exposure by the laser light source. This yields a simple and inexpensive design of the device and thus of the underlying method.

In an advantageous development of the invention it is possible to combine the filter with the film to be exposed and thus to construct it as one part. It is thereby possible to apply the information of the filter directly onto the film, for instance by way of a printing method.

As has been stated, the information layer of the filter according to the invention comprises individual pixels, e.g. in the colors red, green and blue. The pigments of the pixels may be made absorptive or reflective.

The master hologram used according to the invention is preferably made of several layers, so that the individual layers selectively reflect, for instance, the individual color portions of the light of the laser light source that has been decomposed or filtered out by the filter. The master hologram acts here as a mirror which selectively reflects individual colors (laser color beams). This characteristic can also be realized in a single layer of the master hologram, e.g. by sequential or parallel exposure with the respective colors (laser radiation). The layers of the master hologram are here adapted to the wavelengths of the laser light source to be able to reflect these accordingly. According to the invention the master hologram consists preferably of one or several reflection holograms that may have different characteristics, e.g. the effect of a holographic mirror or a holographic ground-glass screen. Likewise, it is possible to use holograms or diffractive optical elements (DOE) with surface structures as patterns.

According to the invention the film to be exposed is positioned between the master hologram and the filter. In accordance with the radiation passing through the filter, the information reflected by the master hologram is copied pixelwise with the available laser wavelengths onto the film. Hence, it is possible according to the invention to copy all information provided on the filter into the photosensitive film and thus to obtain the desired colored information representation.

According to an advantageous development of the invention the film to be exposed is provided with a further filter layer prior to exposure so as to change the information to be exposed. This may take place from picture to picture or also continuously. The filter layer can also be applied by means of a printing technique. In a development of the invention it is possible to provide the master hologram with fixed information or features that may additionally be exposed upon reflection of the laser light of the laser light source onto the film. This additional information of the master hologram may e.g. also consist in a colored design, in a basic pattern or in further pixels. The additional information can here be introduced, for instance while the individual layers of the master hologram are joined, for example through information imposed on the adhesive layer, for instance by introducing regions with a changed refractive index or by introducing color pigments, or the like.

The film according to the invention is preferably a photopolymer film that covers the whole color spectrum. Such a film is for instance sold by the company DuPont under the name “Omnidex”. A polymerization process that ensures a permanent fixation of the introduced information takes place during exposure.

Thus the device of the invention permits the construction of a contact copy of the information, which is positioned on the filter, on the film, resulting in a high degree of information security.

The invention shall now be described with reference to an embodiment in combination with the drawing, in which:

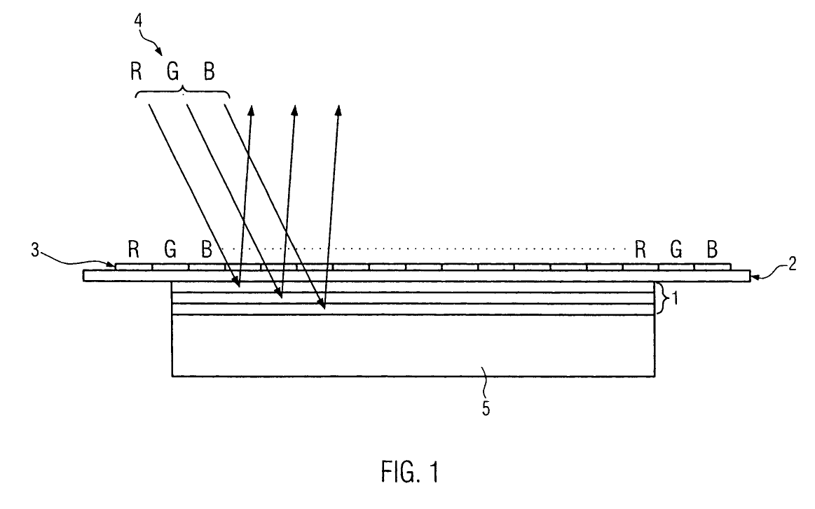

FIG. 1 is a schematic side view of the essential parts of the device according to the invention.

This device comprises a substrate 5 which may e.g. be designed in the form of a glass plate. Three master layers of a master hologram 1 are positioned on the substrate 5. These layers are e.g. reflective for the colors (wavelengths of the entering laser light) red, green, blue.

A film 2 that is to be exposed and is configured as a photopolymer film is arranged on the master hologram 1. A filter 3 which is provided with information formed by individual color pixels, for example by means of an ink jet printing method, is positioned on the film 2. The individual color pixels are reproduced in the colors red, green and blue in the schematic illustration chosen in FIG. 1, whereby e.g. a colored image can be reproduced on the filter 3.

As shown in FIG. 1, an exposure takes place by way of a laser light source 4 which applies laser light, for instance in the colors red, green and blue, onto the whole arrangement, for example by means of a scan method. As shown, the individual colored laser beams pass through the filter 3 and the film 2 and are reflected by the associated layers of the master hologram 1. The film 2 is subsequently exposed by this reflected light so as to produce a reflection hologram in said film.

The present invention is not limited to the described device. Rather, the invention also relates to an associated method for the assignment and exposure of the individual components.

### List of Reference Numerals

1 Master hologram
2 Film
3 Filter
4 Laser light source
5 Substrate

1. A device for producing a reflection hologram, comprising a master hologram (1) which comprises at least one color-sensitive reflective layer, a photosensitive film (2) applied to the master hologram, and a filter (3) which is arranged on the film and through which light is passed onto the master hologram (1) and reflected towards the film (2), and a laser light source (4) which outputs white or monochromatic light, the filter (3) being configured in the form of a transparent film printed with information.

2. The device according to claim 1, characterized in that the laser light source (4) is configured in the form of a laser scanner.

3. The device according to claim 1, characterized in that the filter (3) is provided with colored information.

4. The device according to any one of claim 1, characterized in that the filter (3) is made integral with the film (2).

5. The device according to claim 1, characterized in that the filter (3) is provided pixelwise with information that is only transmissive for selected portions of the laser radiation of the laser light source (4).

6. The device according to claim 1, characterized in that the film (2) is formed as a photopolymer film

7. The device according to claim 1, characterized in that the master hologram (1) is made of several layers.

8. The device according to claim 1, characterized in that the master hologram (1) is made reflective.

9. The device according to claim 1, characterized in that the master hologram (1) comprises at least one reflection hologram.
